(19) United States
(12) Patent Application Publication
(10) Pub. No.: US 2002/0031270 A1
(43) Pub. Date: Mar. 14, 2002

(54) Image processing apparatus, image processing method, and computer readable storage medium

(76) Inventor: Tsutomu Yamazaki, Odawara-Shi (JP)

Correspondence Address: Platon N. Mandros, BURNS, DOANE, SWECKER &MATHIS, L.L.P., P.O. Box 1404, Alexandria, VA, 22313-1404, US

(21) Appl. No.: 09/941,799

(22) Filed: Aug. 30, 2001

(30) Foreign Application Priority Data
Sep. 12, 2000 (JP) 2000-277053

(51) Int. Cl. G06K 9/72; G06K 9/03; G06F 15/00; G06F 17/00; G06F 17/21; G06F 17/24

(52) U.S. Cl. 382/229; 382/309; 707/531

(57) ABSTRACT

An image processing apparatus for changing a layout of a character string and/or a drawing contained in image data is disclosed. The apparatus includes a first detection means, a second detection means, a change means, a recognition means, and a replacing means. The first detection means detects a directive word, which is a character string that indicates a drawing position. The second detection means detects a drawing whose position is indicated by the directive word. The change means changes a layout of the character string and/or the drawing position. The recognition means recognizes positional relation between the directive word and the drawing after a layout change. The replacing means replaces the directive word based on the positional relation.

### BACKGROUND OF THE INVENTION

1. Field of the Invention

The invention relates to the image processing apparatus, image processing method, and computer readable storage medium for changing character strings and/or drawing layouts included in image data.

2. Description of Related Art

Various editing methods have been known for using image data effectively according to the purpose of usage.

Japanese Patent Unexamined Publication No. 8-255160 (A) discloses an editing method for automatically laying out visually recognizable information such as characters, graphics, photographs and images within a specified area. The method provides a means of automatically adding layout information for displaying electronic image data on a display device.

Japanese Patent Unexamined Publication No. 10-228473 (A) discloses a method of automatically generating links between drawings such as diagrams and tables included in the image and the text related thereto, and converting them into hypertexts.

The method includes the steps of detecting captions, detecting specified character strings related to drawings from the captions, and detecting character strings identical to the detected character strings from character areas to generate links between the character strings in the captions and the character strings in the character areas, based on the positional relations between the areas where the diagrams and tables exist and neighboring character areas.

Japanese Patent Unexamined Publication No. 11-85741 (A) discloses an editing method for automatically laying out drawing numbers in optimum positions. The method allocates drawing numbers to drawings automatically according to specified drawing number parameters.

In general, drawings contained in a document are referenced by drawing numbers that contain unique numbers such as “FIG. 1” and “FIG. 2,” or character strings that direct the positions of drawings such as “drawing on the right” and “drawing above.”

However, contrary to drawing numbers that contain unique numbers, character strings that direct the positions of drawings can cause problems if layout changes are applied. For example, a drawing that used to be referenced as “drawing on the right” can move to the left of the character string that used to constitute the “drawing on the right,” or a drawing that used to be referenced as “drawing below” can move to a position above the character string that used to constitute the “drawing below.”

Thus, the character string that indicates the position of a drawing may not match with its positional relation of the drawing after an editing process that accompanies a layout change and may develop a contradiction. This causes a problem of reducing its value as a reference material.

on the other hand, the method disclosed by Publication No. 8-255160 is intended for the layout of documents such as newspapers and magazines where drawing numbers and character strings indicating drawing positions are not indicated. The method disclosed by Publication No. 10-228473 is simply using the existing drawing numbers and character strings indicating drawing positions. The method disclosed by Publication No. 11-85741 is to re-allocate drawing numbers. Therefore, these methods disclosed on the Publications cannot deal with the present problem.

### SUMMARY OF THE INVENTION

A general object of the invention is to provide an image processing apparatus, an image process method and a computer readable storage medium capable of maintaining the consistency between character strings that indicate drawing positions and actual drawing positions before and after layout changes.

It is still more specific object of the invention to provide an image processing apparatus for changing a layout of a character string and/or a drawing contained in image data. The apparatus includes a first detection means, a second detection means, a change means, a recognition means, and a replacing means. The first detection means detects a directive word, which is a character string that indicates a drawing position. The second detection means detects a drawing whose position is indicated by the directive word. The change means changes a layout of the character string and/or the drawing position. The recognition means recognizes positional relation between the directive word and the drawing after a layout change. The replacing means replaces the directive word based on the positional relation.

A further object of the invention is to provide an image processing method for changing a layout of a character string and/or a drawing contained in image data. The method includes the steps of: (a) detecting a directive word, which is a character string that indicates a drawing position; (b) detecting a drawing whose position is indicated by the directive word; (c) changing a layout of the character string and/or the drawing position; (d) recognizing positional relation between the directive word and the drawing after a layout change; and (e) replacing the directive word based on the positional relation.

Still a further object of the invention is to provide a computer readable storage medium for storing a program for executing the aforesaid image processing method.

The objects, characteristics, and advantages of this invention other than those set forth above will become apparent from the following detailed description of the preferred embodiments, which refers to the annexed drawings.

### BRIEF DESCRIPTION OF THE DRAWINGS

FIG. 1 is a block diagram of an image processing system according to an embodiment of this invention;

FIG. 2 is an example allocation table used for consistency process on an image processing apparatus of the image processing system;

FIG. 3 is a flow chart of the consistency process;

FIG. 4 is a flowchart of a first correlating process in the consistency process;

FIG. 5 is an example input image;

FIG. 6 is an example allocation table after the first correlating process;

FIG. 7 is a flow chart of an updating process to an allocation table in the consistency process;

FIG. 8 is an example of the allocation table after the updating process;

FIG. 9 is a flowchart of a second correlating process in the consistency process;

FIG. 10 is a flow chart of a process for detecting positional relation between a first directive word and a drawing in the second correlating process;

FIG. 11 is a schematic representation of assistance in explaining the positional relation between the first directive word and the drawing;

FIG. 12 is an example allocation table after the second correlating process; and

FIG. 13 is an example output image.

### DETAILED DESCRIPTION OF THE EMBODIMENTS

The embodiments of this invention will be described below with reference to the accompanying drawings.

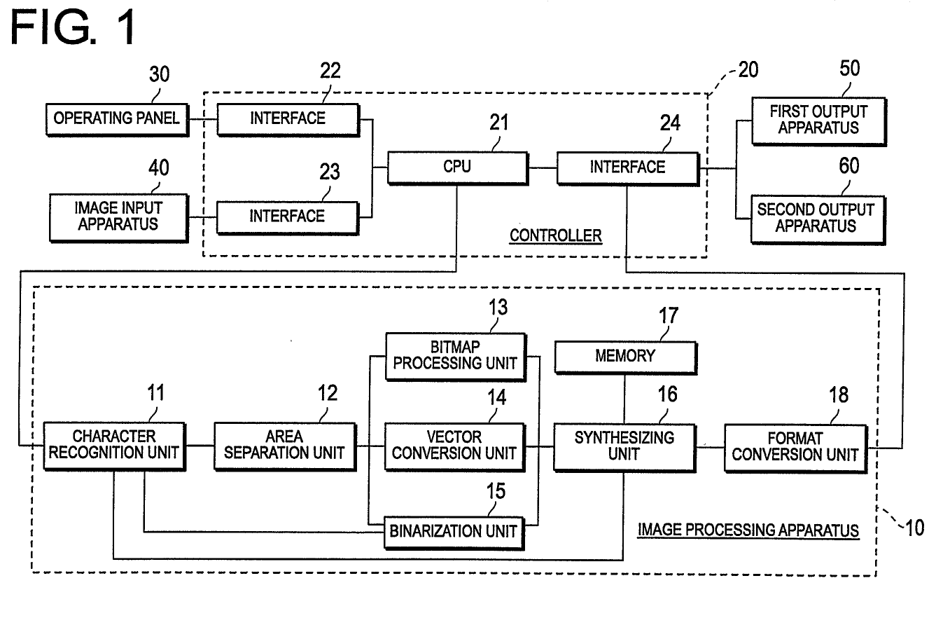

The image processing system shown in FIG. 1 has an image processing apparatus 10, a controller 20, an operating panel 30, an image input apparatus 40, a first output apparatus 50, and a second output apparatus 60.

The image processing apparatus 10 has a character recognition unit 11, an area separation unit 12, a bitmap processing unit 13, a vector conversion unit 14, a binarization unit 15, a synthesizing unit 16, a memory 17, and a format conversion unit 18.

The controller 20 has an interface 22 for the operating panel 30, an interface 23 for the image input apparatus 40, an interface 22 for the first output apparatus 50 and the second output apparatus 60, and a central processing unit (CPU) 21 for controlling the interfaces 22 through 24.

The operating panel 30 is used by the operator for inputting instructions. The image input apparatus 40 is an image reading apparatus such as a color scanner. The first output apparatus 50 is an image forming apparatus such as a color printer, and the second output apparatus 60 is a apparatus for displaying and data processing the image data to be outputted, for example, a computer equipped with a display device.

Functions of each unit will be described in detail along the operation flow.

The user inputs the instruction information using the operating panel 30. The instruction information can be, for example, an operation start instruction or an instruction for a manual setting item.

Manual setting items include a scaling factor setting, an instruction of the N-in-1 process, a layout change setting, a consistency process instruction, a post-processing selection, a readout mode, and an output format selection.

The N-in-1 process is the process of reducing the size of and synthesizing a plurality of sheets of document images and laying them out as a single page image.

In the layout change setting, one of the three modes, i.e., no priority, character priority, or graphics priority, can be selected. In the character priority mode, it is guaranteed that the character size after the reduction of character areas will not be smaller than the predetermined value. In the graphics priority mode, the size of the character area will be maintained constant when the images are enlarged.

The consistency process is to maintain the consistency between the directive words as character strings for directing the positions of drawings and the actual positions of the drawings. In other words, it is the process of preventing the characters contained in a directive word that represents a position and the actual position of the related drawing after the layout change from corresponding and contradicting.

The post-processing selection is a mode for selecting the post-processing that is applied to the three types of areas separated in the character recognition unit 11 and the area separation unit 12, i.e., character areas, graphics areas,and photographic areas. The post-processing includes character coding at the character recognition unit 11, bitmap processing at the bitmap processing unit 13, vector conversion at the vector conversion unit 14, and binarization at the binarization unit 15.

The readout mode consists of the color mode for treating a document image as a color image and a monochromatic mode for treating a document image as a monochromatic image at the image input apparatus 40.

The output format selection is a mode for selecting the format of the output file to be prepared at the format conversion unit 18. The output formats are general-purpose file formats, e.g., the document file format, the page description language format, the file format for document display, and the file format for storing images.

For example, the document file format is the Rich Text Format, the page description language format is the PostScript (R), the file format for document display is the PDF (Portable Document Format), and the file format for storing images is either the JPEG (Joint Photographic Experts Group) or the TIFF (Tagged Image File Format).

The instruction information from the operating panel 30 is transmitted to the controller 20 via the interface 22.

As it receives instruction information for the manual setting items, the controller 20 inputs the manual setting items to the image processing apparatus 10. Furthermore, as it receives the operation start instruction, the controller 20 instructs the image input apparatus 40 to start reading images either in the color mode or in the monochromatic mode according to the readout mode setting.

The image input apparatus 40 reads the document image according to the operation start instruction from the controller 20. The generated image data is transmitted to the character recognition unit 11 of the image processing apparatus 10 via the interface 23 of the controller 20.

The character recognition unit 11 separates character areas from the image data and extract character images existing in the character areas. The image data left after removing the character images are inputted into the area separation unit 12. The character recognition unit 11 extracts character information including character code data and positional information, and color information from the character images.

The positional information includes X-Y coordinates, widths, lengths, number of characters, etc. The character information are inputted into the synthesizing unit 16. When binarization is specified as the post-processing of the output area by the user, the character area is inputted into the binarization unit 15.

The area separation unit 12 separates graphics areas and photographic areas from the image data. The photographic area data will be added with positional information such as X-Y coordinates, widths and lengths,.and will be inputted into the bitmap processing unit 13.

On the other hand, the data in the graphics area will be added with positional information and will be inputted into the vector conversion unit 14. If the post-processing is specified, the image data after area separation will be inputted into the bitmap processing unit 13 or the vector conversion unit 14 or the binarization unit 15 according to the details of specified matter.

The bitmap processing unit 13 applies the bitmap processing to the data in the photographic area. In the bitmap processing, the data of the photographic area is applied with various image processes such as the edge correction, the smoothing and the MTF correction. The bitmap information including the bitmap data and the positional information will be inputted into the synthesizing unit 16. The bitmap processing unit 13 will execute the similar process to the image data, to which the bitmap processing is specified as the post-processing.

The vector conversion unit 14 applies vector-conversion to the data in the graphics area to generate vector data. The vector data is inputted into the synthesizing unit 16 together with the attribute data. The vector conversion means converting graphics consisting of dots into vector data such as straight lines, arcs, Bezier curves, etc.

The attribute data are data obtained by extracting line widths, line types, line colors, end point styles, and colors of enclosed areas surrounded by vector data. The vector conversion unit 14 executes the similar process to image data, to which vector conversion is designated as the post-processing.

The binarization unit 15 binarizes the image data from the character recognition unit 11 and/or the area separation unit 12, when the binarization process is specified as the post-processing. The binarization data is inputted into the synthesizing unit 16 with the positional information.

The synthesizing unit 16 synthesizes the input data from the character recognition unit 11, the bitmap processing unit 13, the vector conversion unit 14, and the binarization unit 15. The synthesized data is converted into intermediate format data and inputted into the format conversion unit 18.

The intermediate format data are intermediate data between the synthesized data and the output format data, and are generated in order to facilitate the processing at the format conversion unit 18. The synthesizing unit 16 executes the consistency process using the allocation table according to the manual setting items.

In the consistency process, the corresponding relation between the drawing and the first directive word, which is the character string that directs the position of the drawing before the layout change is detected, the positional information of the first directive word and the drawing are updated according to the layout change, the second directive word, which is character string that directs the position of the drawing after the layout change, is generated based on the corresponding relation and the updated positional information between the first directive word and the drawing, and the first directive word is replaced by the second directive word. The first directive word and the second directive word are, for example, “drawing on the right” or “drawing above.”

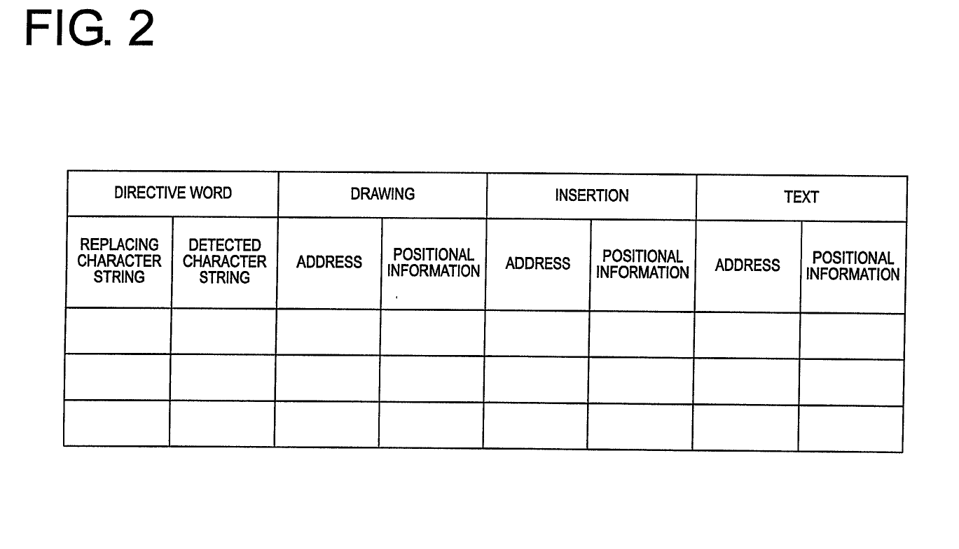

The allocation table has, as shown in FIG. 2, the directive section, the drawing section, the insertion section, and the text section. In the directive section, the first directive word and the second directive word are set up as detected character string and the replacing character string respectively.

In the drawing section, memory address and the positional information of the drawing that corresponds to the first directive word are setup. In the insertion section, memory address and the positional information of the first directive word are setup. In the text section,memory address and the positional information of the character code data that belongs to the character area are set up.

The memory 17 is used for storing the allocation table and the input data for and the synthesizing unit 16.

The format conversion unit 18 converts the intermediate format data into the data of the specified output format. The output format data is inputted into the first output apparatus 50 and/or the second output apparatus 60 via the interface 24.

As an example, the first output apparatus 50 prints the data on paper, and the second output apparatus 60 stores the data and displays it on the monitor.

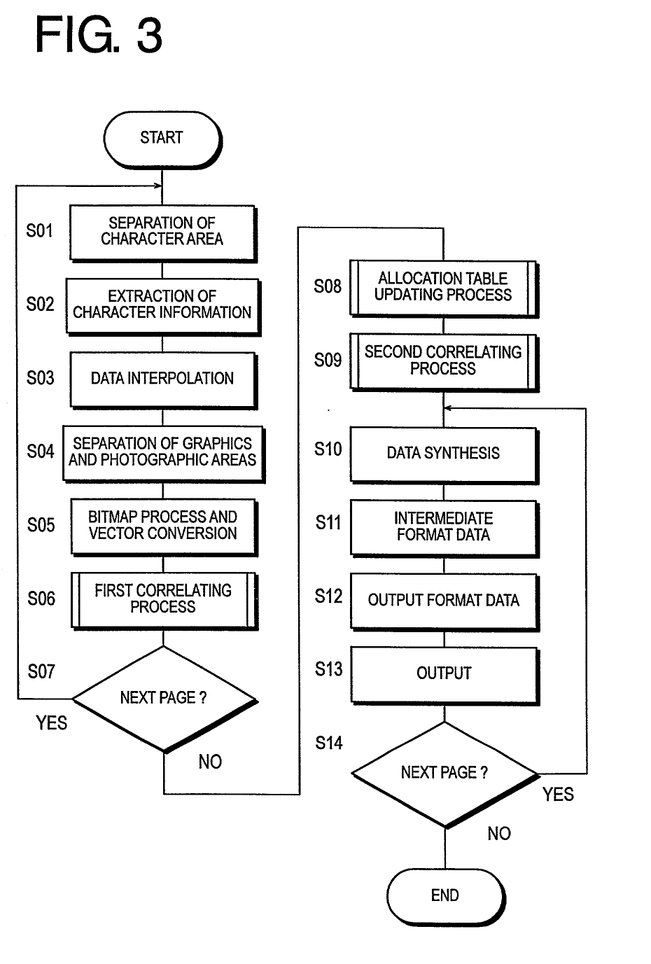

Next, the consistency process will be described referring to the flow chart shown in FIG. 3.

First, character areas are separated from the image data (step Si), and the character information is extracted from character images in the character areas (step S2). The image data, from which the character images are removed, are interpolated using the peripheral pixels of the character images (step S3). Then, photographic areas and graphics areas are separated from the image data (step S4). The photographic area data are treated by the bitmap process, and the graphics area data are treated by the vector conversion process (step S5).

After that, the first correlating process concerning the allocation table will be executed based on the character information, the bitmap information, and the vector data (step S6). The first correlating process is a process of detecting the corresponding relation between a drawing and the first directive word, which is the character string that directs the position of the drawing before the layout change.

Next, a judgment will be made whether there is a next page image data (step S7). If it is judged that there is a next page, the process returns to the step S1. If the next page does not exist, or if the process of the last page is completed, the allocation table updating process will be executed (step S8). The updating process of the allocation table is a process of updating the positional information of the first directive word and the drawing.

Then, the second correlating process is executed to obtain the final allocation table that will be used for data synthesizing (step S9). The second correlating process is a process of generating the second directive word, which is the character string that directs the drawing position after the layout change, based on the corresponding relation and the updated positional information of the first directive word and the drawing, and replacing the first directive word with the second directive word.

Next, the image data will be synthesized based on the allocation table (step S10), and the image data will be converted into the intermediate format data (step Si1). The intermediate format data will be converted into the specified output format data (step S12) and outputted (step S13).

Lastly, a judgment is made whether there is a next page image data based on the allocation table (step S14). If it is judged that there is a next page, the process returns to the step S10. If the next page does not exist, or if the process of the last page is completed, the process will be terminated.

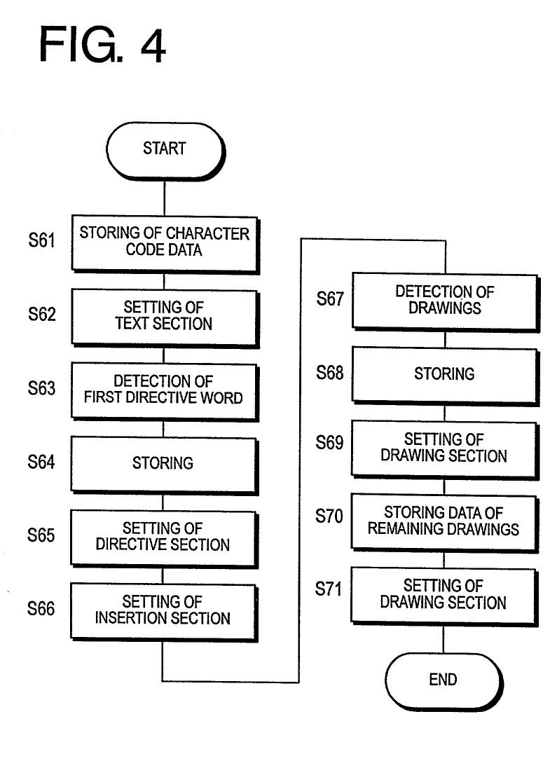

Next, the first correlating process will be described referring to the flow chart shown in FIG. 4. 721 First, the character code data that belongs to the character area will be stored in the memory 17 (step S61). The memory address and the positional information of the character code data will be set up into the text section of the allocation table (step S62).

Next, the first directive word contained in the character code data will be detected (step S63), and the first directive word's data will be stored in the memory 17 (step S64). Then, the first directive word will be set up in the directive section of the allocation table as the detected character string (step S65), and the memory address and the positional information of the first directive word will be set up in the insertion section of the allocation table (step S66).

After that, the drawing that corresponds to the first directive word will be detected based on the direction the first directive word is directing, the coordinate position of the first directive word, and the bitmap data of the photographic area or the vector data of the graphics area located in the vicinity of the first directive word (step S67).

The detected drawing's data will be stored in the memory 17 (step S68). The memory address and the positional information of the detected drawing will be set up in the drawing section of the allocation table being correlated with the first directive word (step S69).

Then, the data of the remaining drawings that consist of the bitmap data and/or vector data that are not correlated to the first directive word will be stored in the memory 17 (step S70). The memory address and the positional information of the remaining drawings' data will be set up in the drawing column of the allocation table without being correlated with the directive (step S71).

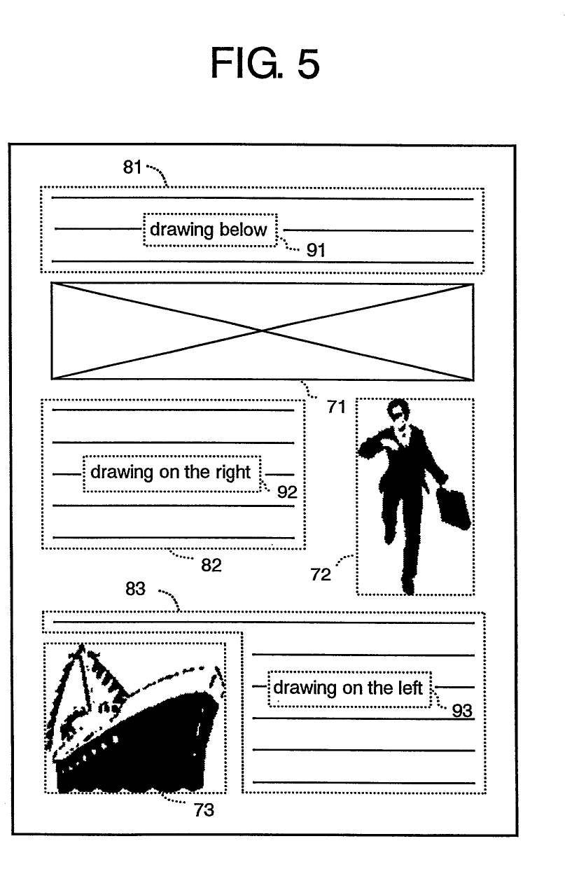

Next, the first correlating process will be described more specifically using an image shown in FIG. 5. 78

First, the character code data existing in the character areas 81, 82 and 83 is stored in the first storage area of the memory 17. The memory address and positional information of the character code data are set up in the text section of the allocation table. The starting addresses of the data of the character areas 81, 82 and 83 are shown as Cadr1, Cadr3 and Cadr5.

Then, “drawing below,” “drawing on the right” and “drawing on the left” contained in the character code data of character areas 81, 82 and 83 will be detected as the first directive words 91, 92 and 93. The data of the first directive words 91, 92 and 93 will be stored in the first storage area of the memory 17. Furthermore, the first directive words 91, 92 and 93 will be set up in the directive section of the allocation table as the detected character strings. The memory addresses and positional information of the first directive words 91, 92 and 93 will be set up in the insertion section of the allocation table. The starting addresses of the data of the first directive words 91, 92 and 93 are shown as Cadr2, Cadr4 and Cadr6.

Next, a drawing 71 that consists of vector data of a graphics area located in the direction indicated by “drawing below,” which is the first directive word 91, will be detected as the drawing corresponding to the first directive word 91. Similarly, drawings 72 and 73 consisting of the bitmap data of the photographic areas will be detected as the drawings corresponding to the first directive words 92 and 93.

The data of the drawings 71, 72 and 73 will be stored in the second storage area of the memory 17. The memory addresses and positional information of the drawings 71, 72 and 73 will be set up into the drawing section of the allocation table in correlation with the first directive words 91, 92 and 93. The starting addresses of the drawings 71, 72 and 73 will be shown as Fadr1, Fadr2 and Fadr3.

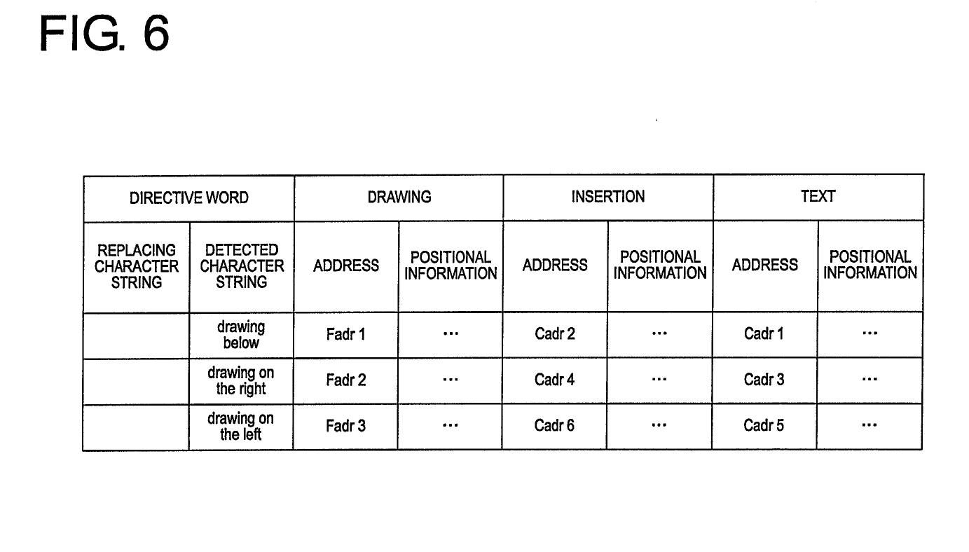

Thus, the data such as shown in FIG. 6 are set up in the allocation table.

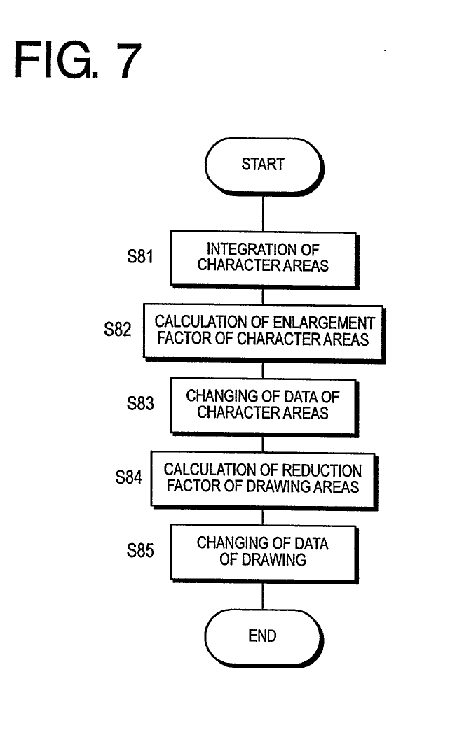

Next, the updating process of the allocation table will be described referring to the flow chart shown in FIG. 7. Let us take a layout case as an example where the character areas 81 through 83 in the image shown in FIG. 5 are to be enlarged and arranged at the top of the sheet, while the FIGS. 71 through 73 are to be reduced and arranged at the bottom of the sheet.

First, the data in the character areas 81 through 83 are integrated (step S81), and the enlargement factor of an area 80 to which the character areas 81 through 83 are to be plugged in is calculated (step S82). Then, the data of the character areas 81 through 83 stored in the second storage area will be changed according to the enlargement factor and the layout setting, the memory addresses Cadr3 and Cadr5 as well as the positional information stored in the text section will be removed, and the memory address Cadr1 and the positional information will be changed (step S83).

Simultaneously, the data of the first directive word 91 through 93 will be changed and the memory addresses Cadr2, Cadr4 and Cadr6 as well as the positional information will be changed. The memory addresses after the change will be shown as Cadr1′, Cadr2′, Cadr4′ and Cadr6′.

After that, the reduction factor for drawing area, i.e., the area where the drawings 71 through 73 are to be placed is calculated (step S84). Then, the data of the drawings 71 through 73 stored in the second storage area are changed based on the reduction factor and the layout setting, and the memory addresses and the positional information of the drawing section will be changed (step S85). The memory address after the change will be shown as Fadr1′ through Fadr3′.

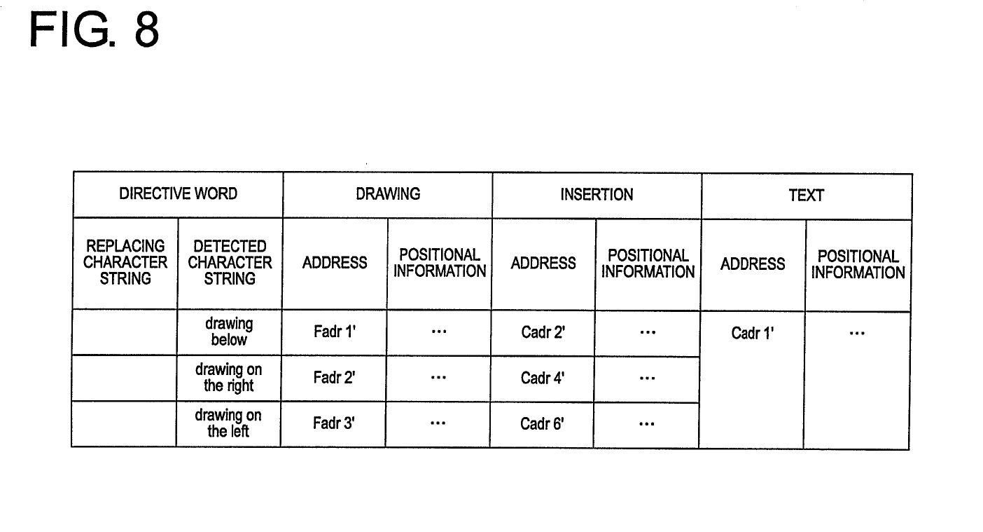

As a result of the above, the data of the allocation table shown in FIG. 6 will be updated and the allocation table shown in FIG. 8 will be obtained.

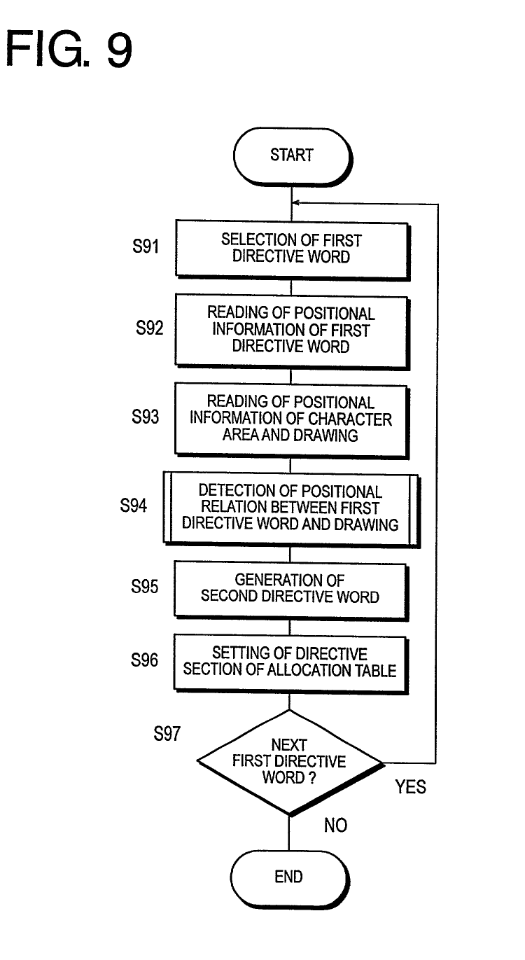

Next, the second correlating process will be described referring to the flow chart shown in FIG. 9.

First, a first directive word that does not have a correlated second directive word will be selected (step S91), and the positional information of the first directive word will be read (step S92). Then, the positional information of the character area and the drawing correlated to the first directive word will be read (step S93).

Next, the process of detecting positional relation between the first directive word and the drawing will be executed based on the positional information of the character area and the drawing (step S94). After that, a second directive word is generated based on the positional relation (step S95), and the second directive word will be se up in the directive section of the allocation table as the replacing character string (step S96).

Lastly, a judgment will be made whether any other first directive word that does not have a correlated second directive word exist (step S97). If it is judged that the next first directive word exists, the process returns to the step S94 and the process will be repeated. On the other hand, if it is judged that the next first directive word does not exist, the process will be terminated.

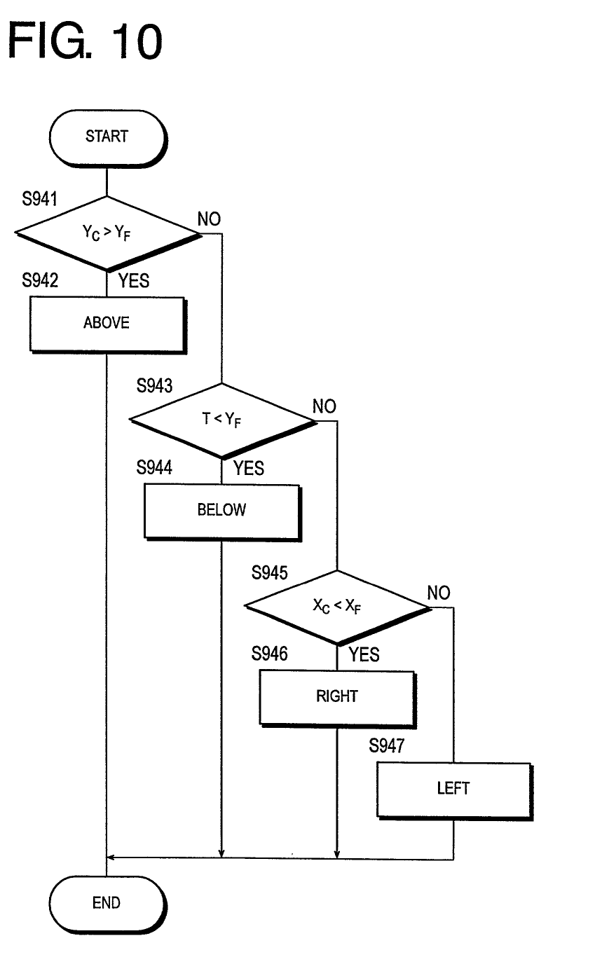

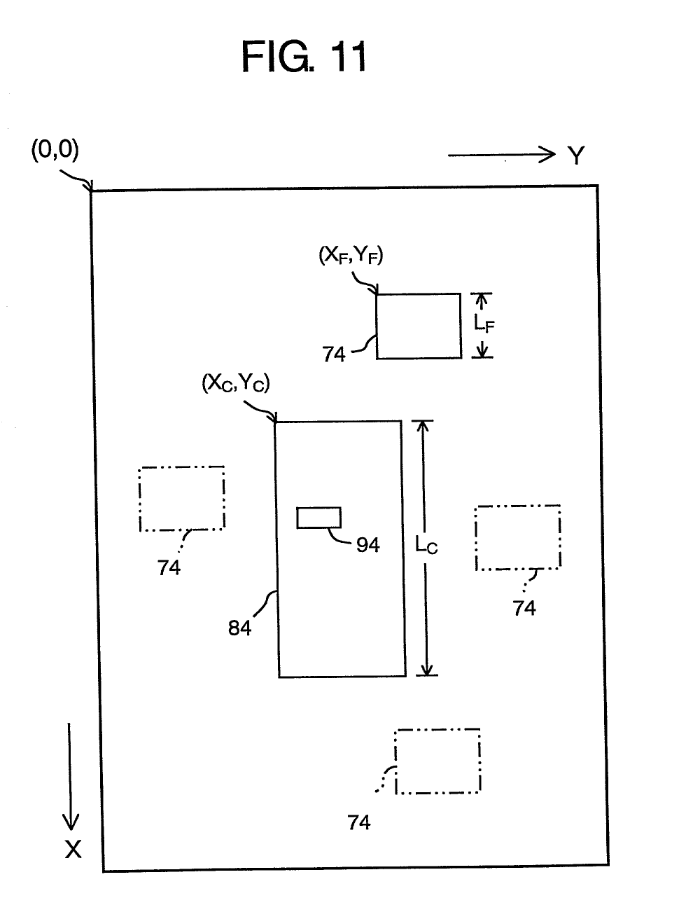

Next, the process of detecting the positional relation between the first directive word and the corresponding drawing will be described referring to FIG. 10 and FIG. 11 taking a case of using the starting coordinates and lengths of the character areas and drawings as an example.

First, the Y-axis value Y_{C} of a character area 84 where a first directive word 94 exists, correlated to the first directive word 94 and the Y-axis value Y_{F} of a drawing 74 correlated to the first directive word 94 are compared (step S941). If the value Y_{C} is judged to be greater than Y_{F}, the drawing 74 is considered to be located about the character area 84 (step S942). Therefore, the second directive word generated in the step S95 will be “drawing above.”

If the value Y_{C} is judged to be equal to or be smaller than YF, a further comparison between the value Y_{F} and the sum T of the value Y_{C} and the length L_{C} of the character area 84 will be made (step S943). If the sum T is judged to be smaller than the value Y_{F}, the drawing 74 is considered to be located below the character area 84 (step S944). Therefore, the second directive word generated in the step S95 will be “drawing below.”

If the sum T is judged to be equal to or greater than the value Y_{F}, the X-axis value X_{C} of the character area. 84 will be further compared with the X-axis value X_{F} of the drawing 74 (step S945). If X_{C} is judged to be smaller than X_{F}, the drawing 74 is considered to be located on the right side of the character area 84 (step S946). Therefore, the second directive word generated in the step S95 will be “drawing on the right.”

If X_{C} is judged to be equal to or greater than X_{F}, the drawing 74 is considered to be located on the left side of the character area 84 (step S947). Therefore, the second directive word generated in the step S95 will be “drawing on the left.”

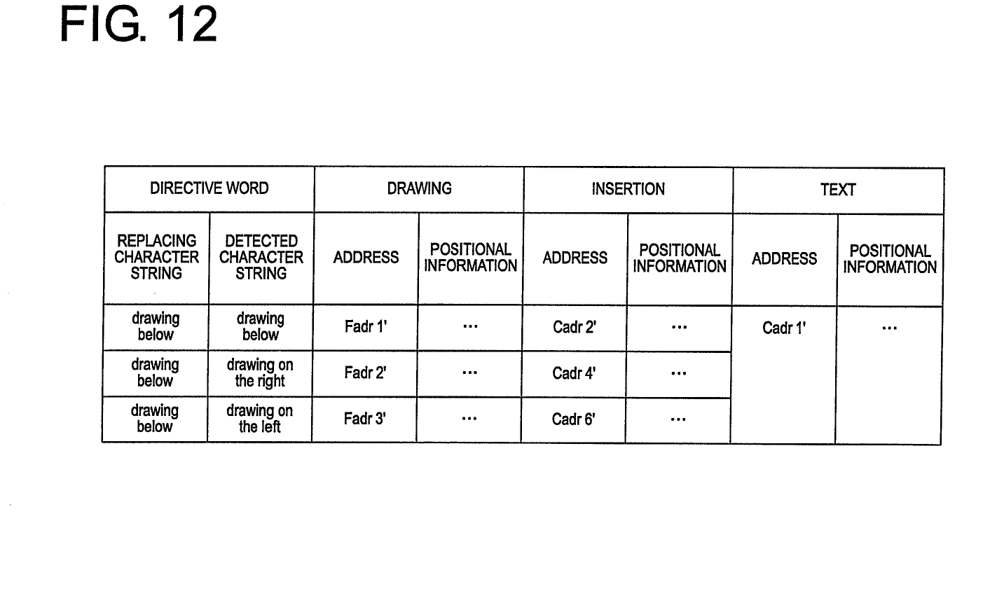

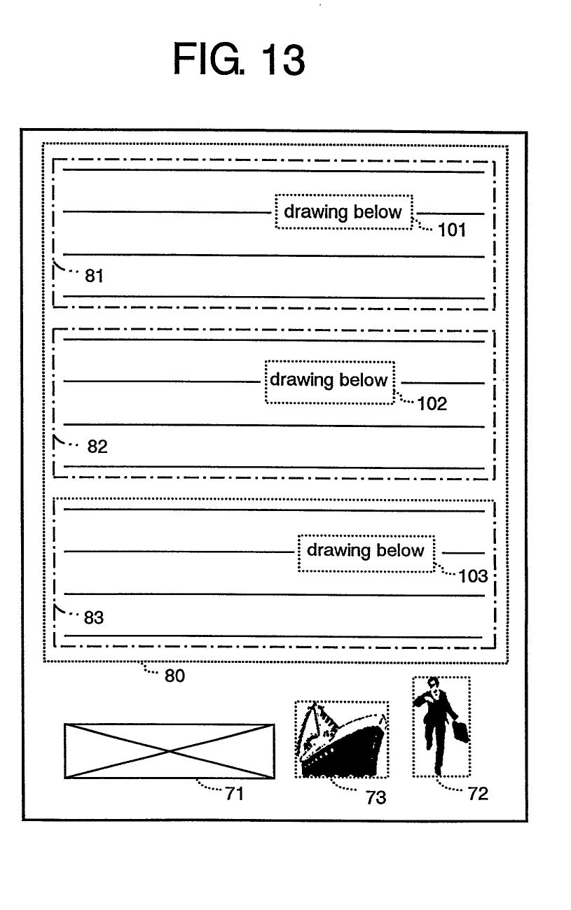

Thus, the allocation table shown in FIG. 12 is obtained. The image shown in FIG. 13 is outputted as a result of reading the data from the memory 17 based on the allocation table and synthesizing the data. Therefore, the second directive words 101, 102 and 103 are “drawing below,” “drawing below” and “drawing below,” and correspond with the positions of the drawings 71, 72 and 73.

Consequently, it is possible to maintain the consistency between drawing positions and directive words, which are the character strings that indicate the drawings positions, before and after a layout change. Hence, it eliminates the problem of causing mismatches between the directive words and drawing positions after a layout change and contradictions, and reducing values of the document.

It is obvious that this invention is not limited to the particular embodiments shown and described above but may be variously changed and modified without departing from the technical concept of this invention.

The invention is applicable to such layout change processes as the N-in-1 process, the page orientation changes (portrait vs. landscape), etc. In those cases, the only difference is in the allocation table updating process influenced by the layout change process, and the first and second correlating processes remain the same.

The invention is applicable not only to a system including a plurality of apparatuses, but also to standalone equipment such as digital copying machines.

It is also possible to make a computer function as an image processing apparatus by providing a program product containing the code data of the programmed image processing method. Such a program product includes a program itself and a storage medium that contains the program.

What is claimed is:

1. An image processing apparatus for changing a layout of a character string and/or a drawing contained in image data, the apparatus comprising:
a first detection means for detecting a directive word, which is a character string that indicates a drawing position;
a second detection means for detecting a drawing whose position is indicated by the directive word;
a change means for changing a layout of the character string and/or the drawing position;
a recognition means for recognizing positional relation between the directive word and the drawing after a layout change; and
a replacing means for replacing the directive word based on the positional relation.

2. An image processing apparatus as claimed in claim 1, in which the detection of the drawing by said second detection means is based on a direction the directive word is directing.

3. An image processing method for changing a layout of a character string and/or a drawing contained in image data, the method comprising the steps of:
(a) detecting a directive word, which is a character string that indicates a drawing position;
(b) detecting a drawing whose position is indicated by the directive word;
(c) changing a layout of the character string and/or the drawing position;
(d) recognizing positional relation between the directive word and the drawing after a layout change; and
(e) replacing the directive word based on the positional relation.

4. An image processing method as claimed in claim 3, in which the detection of the drawing in said step (b) is based on a direction the directive word is directing.

5. A computer readable storage medium for storing a program for executing an image processing method for changing a layout of a character string and/or a drawing contained in image data, in which the method comprising the steps of:
(a) detecting a directive word, which is a character string that indicates a drawing position;
(b) detecting a drawing whose position is indicated by the directive word;
(c) changing a layout of the character string and/or the drawing position;
(d) recognizing positional relation between the directive word and the drawing after a layout change; and
(e) replacing the directive word based on the positional relation.

6. A conputer readable storage medium as claimed in claim 5, in which the detection of the drawing in said step (b) is based on a direction the directive word is directing.
